(19) United States
(12) Patent Application Publication
(10) Pub. No.: US 2010/0194673 A1
(43) Pub. Date: Aug. 5, 2010

(54) Device and a method for an image sensor and a method for manufacturing an image sensor

(75) Inventors: Alan Perrett, Tokyo (JP); Hannu Kakkori, Tokyo (JP); Johan Bergquist, Tokyo (JP)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 12/322,854

(22) Filed: Feb. 5, 2009

(51) Int. Cl. G09G 3/36

(52) U.S. Cl. 345/90

(57) ABSTRACT

A device comprises an image sensor having a group of pixels, wherein each pixel of the group of pixels comprises a microlens located on top of the pixel, the microlens being configured to transmit light to the pixel. The device further comprises at least one optical element, wherein each pixel of the group of pixels is covered with an optical element. The optical element comprises two transparent electrode layers aligned with the covered pixels, and a material between the two transparent electrode layers, the material being configured to change its refractive index when a voltage is applied over it, wherein the device is configured to control the transmission of the light to the covered pixels by varying the voltage of the electrode layer being aligned with the covered pixels. The invention also relates to a method and to a method for manufacturing an image sensor.

### TECHNICAL FIELD

This invention relates to a device and to a method for improving a performance of an image sensor. The invention also relates to manufacturing an image sensor.

### BACKGROUND OF THE INVENTION

CMOS (Complementary Metal Oxide Semiconductor) and CCD (Charge Coupled Device) image sensors are known in digital camera technology. The operation between these sensors is different. For CCD sensor's each pixel reacts to light and stores the electrical charge caused by the light, which charge is further transmitted to be converted to a voltage. In the CMOS sensor, each pixel, on the other hand, is configured to convert the charge to voltage whereby the charge does not need to be transmitted anywhere. In addition to the charge-to-voltage conversion, a CMOS sensor may include other signal processing means as well.

Because of fewer processing steps, CMOS sensors are cheaper than CCD sensors and therefore also more widely used. However, CMOS sensors, in common with CCD sensors, also have certain unwanted effects. One of these is that the light level incident on the pixel varies spatially due to various macro- and micro-optical effects leading to the need for extensive correction processing, either in hardware or software. This processing typically degrades signal-to-noise-ratio of the image being processed, whilst restoring the light balance. Another effect is that the response of the pixels to different colours is not uniform, which requires more processing to correct the colour balance.

In order to remove these effects, a combination of digital processing to remove luminance and colour imbalances, and a mechanical neutral density filter to reduce the light level in all of the image is used in the related technology. However, the mechanical neutral density filter is physically bulky, expensive and unreliable. Further, the digital processing is time consuming if done in software, and requires electrical current and silicon area if done in hardware. In addition it degrades the signal-to-noise ratio of the image, whereby an improved solution is needed.

### SUMMARY OF THE INVENTION

The present solution relates to an improvement in the performance of imaging sensors. In the following a CMOS imaging sensor is used as an example, but it is appreciated that the improvement could also be used in CCD sensors. CMOS sensors are commonly used in digital cameras, as well as in cameras used in mobile phones. The solution provides a small electronic version to replace the mechanical neutral density (ND) filter for reducing light of all wavelengths and colours in the image equally. The present solution uses a technique known from the LCD (liquid crystal display) industry to create a variable power lens, positioned directly above, or more precisely forming part of the conventional micro lens structure. The structure can be created by using conventional IC (Integrated Circuit) processing techniques so the alignment is as good as the original pixels' alignment, and the additional cost is much less than the price of a mechanical structure, used as part of the macro lens system which can be used to produce some of the advantages.

In some embodiments, a device comprises an image sensor having a group of pixels, wherein each pixel of said group of pixels comprises a microlens located on top of the pixel, said microlens being configured to transmit light to the pixel, and at least one optical element, wherein each pixel of said group of pixels is covered with an optical element, said optical element comprising two transparent electrode layers aligned with the covered pixels, and a material between said two transparent electrode layers, said material being configured to change its refractive index when a voltage is applied over it, wherein the apparatus is configured to control the transmission of the light to the covered pixels by varying the voltage of the electrode layer being aligned with the covered pixels.

In an embodiment, a method for an imaging device comprises at least an image sensor having a group of pixels, wherein each pixel of said group of pixels comprises a microlens located on top of the pixel, said microlens being configured to transmit light to the pixel, and at least one optical element, where each pixel of said group of pixels is covered with an optical element, said optical element comprising two transparent electrode layers and a material, the refractive index of which is changed when a voltage is applied over it, between said two transparent electrode layers, and wherein one of the transparent electrode layers is aligned with the covered pixels, wherein the method comprises controlling the transmission of the light to the covered pixels by varying the voltage of the electrode layer being aligned with the covered pixels.

In an embodiment, a method for manufacturing an image sensor comprises a group of pixels, wherein each pixel of said group of pixels comprises a microlens located on top of the pixel, said microlens being configured to transmit light to the pixel, and at least one optical element, wherein the method comprises covering each pixel of said group of pixels with an optical element, said optical element comprising two transparent electrode layers and a material, the refractive index of which is changed when a voltage is applied over it, between said two transparent electrode layers, aligning one of the transparent electrode layers with the covered pixel, the image sensor being configured to control the transmission of the light to the covered pixels by varying the voltage of the electrode layer being aligned with the covered pixels.

The present solution provides an electronic version of a mechanical ND filter personally for each pixel or for group of pixels. Because the fabrication uses both standard IC and LCD display techniques, the implementation of the present solution may be inexpensive. Also the alignment of the electrodes determines the accuracy of the device, and that can be as accurate as the processing of the pixels.

In addition to adding the ND filter, the per-pixel basis of the present solution means that a range of corrections for luminance and colour variation can be achieved without the time or noise penalty of digitally correcting the image. Colour matrix balancing and Relative Illumination (RI) or Vignetting balancing, as well as an improvement of the performance of the microlens for the particular colour being imaged are shown. The solution also allows hotspot cancelling (e.g. from flash light) even in edge and centre luminance.

It should be noted that despite using a LC (Liquid Crystal) material, the present solution does not rely on a polariser as conventional liquid crystal displays do. Thus there is no associated loss of light.

It can be appreciated that if a polariser were added to the coating on the top glass surface, then it would be possible to more completely cut off the light to the pixel, leading to an electronic shutter effect. If a suitable analogue voltage is applied then full variability between on and off could be achieved and this would allow the dynamic range of the sensor to be extended as described for the variable power lens implementation. However the transmission of light in the ‘on’ state would be affected by the polariser. With circularly polarised incident light then half the energy incident on the sensor would be lost even in the ‘on’ state.

There is no wiring requirement on the surface of the pixel, and therefore no light is lost due to opaque features. The extra wiring that is needed can be accommodated within the normal wiring layers of the CMOS sensor. Therefore the solution can be implemented simply at the silicon level.

### DESCRIPTION OF THE DRAWINGS

The present solution will be described in the following with reference to drawings, where

FIG. 1 illustrates a cross-section of a CMOS sensor pixel,

FIGS. 2a, 2b illustrate an example of a pixel structure diagrammatically,

FIGS. 3a, 3b illustrate examples of voltage switchable lenses,

FIG. 4 illustrates an example of a per-pixel optics diagrammatically,

FIGS. 5a, 5b illustrate examples of a pixel structure having a LCD cell, and

FIGS. 6a, 6b illustrate another examples of a pixel structure having a LCD cell, and

FIG. 7 illustrates an example of an electronic device.

### DETAILED DESCRIPTION

A CMOS image sensor comprises pixels in the form of an array. These pixels have an active area, at the bottom of a well, where photons are turned into electrons. Consequently, to try to maximise the amount of light gathered, the top of the well includes a solid lens, i.e. microlens, structure to redirect slightly off-axis light to the active area, which does not fill the entire bottom of the well. According to the manufacturing process of the present solution, a transparent electrode is printed on the top or bottom surface of a microlens by using e.g. known lithography processes. One electrode may be printed per micro lens, and connected electrically to the underlying pixel through conventional IC signal tracking. A layer of LC material or similar is arranged on the top of this, after which a transparent top (e.g. a glass sheet) is encapsulated with further transparent electrode printed on it. By varying the voltage on the microlens electrodes, the refractive index of the liquid crystal can be varied. The effect will be to vary the power of the microlens and so vary the transmission of light to the pixel. The microlens power can be adaptive on a per-pixel basis.

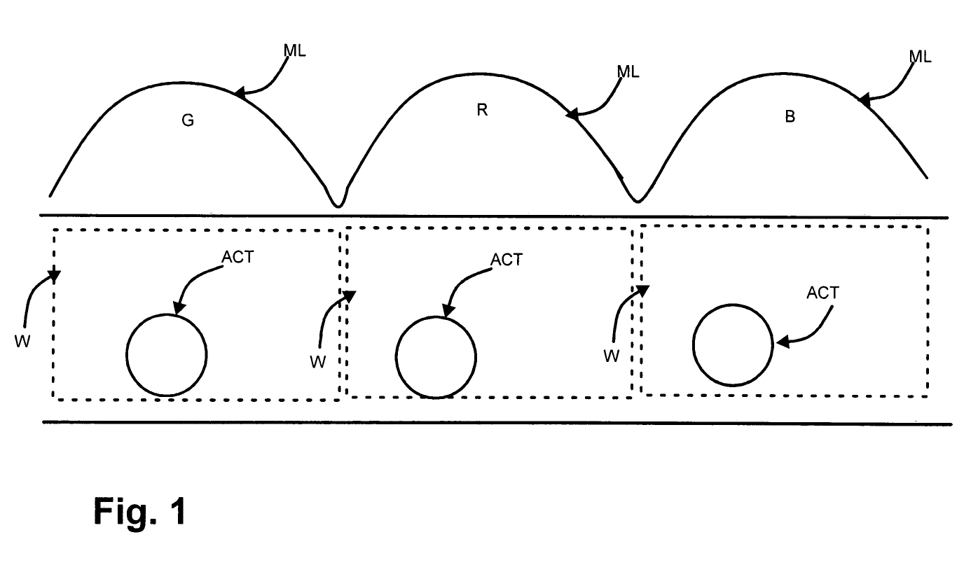

FIG. 1 illustrates a cross section of a CMOS pixel presented in a large-scale. The hemispherical shapes at the top of the structure are the micro lenses “ML” and the circles “ACT” at the bottom show the positions of active pixel areas. It can be seen that the active areas are at the bottom of a well “W”. The sides of the well are formed by the bulk silicon, implanted silicon and metal layers etc. Only light incident on the active area of the silicon forms part of the image.

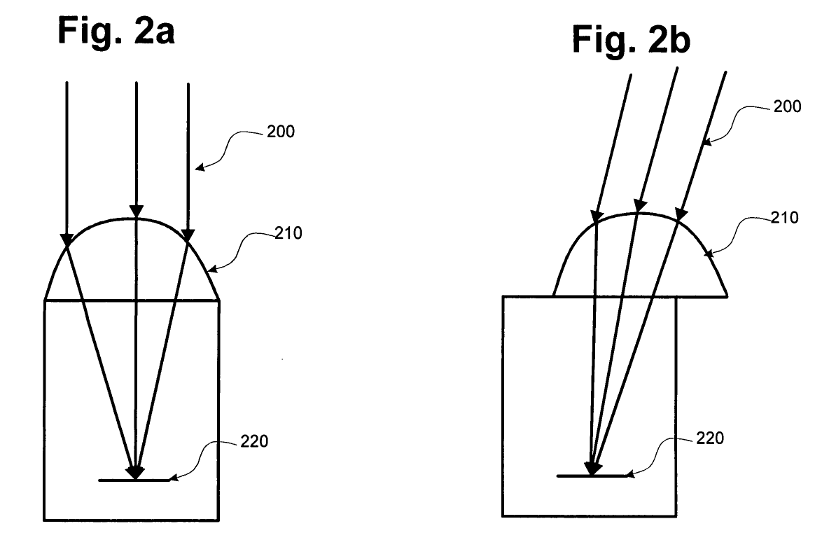

FIGS. 2a and 2b illustrate diagrammatically a pixel structure with light rays 200. As is realized from FIGS. 2a, 2b, the action of the microlens 210 is to concentrate the incoming light 200 onto the active area 220 of the pixel. At the edge of the sensor (FIG. 2b), the light 200 is incident on the pixel/lens combination at an angle, and to increase the efficiency of the lens, the lens is typically offset from the actual pixel structure by an amount dependent on the distance of the pixel from the optical centre of the sensor.

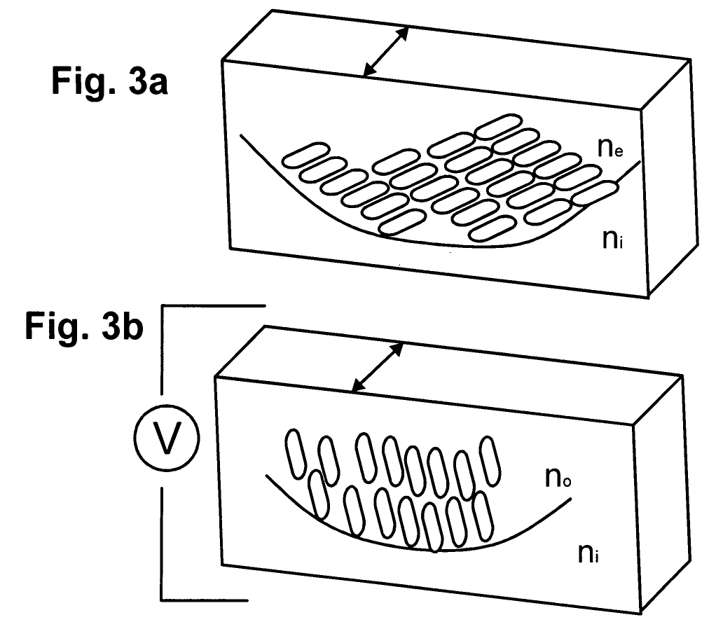

FIG. 3 illustrates an example of voltage switchable lens. The lens has no power (it is the same optically as a transparent flat sheet), when nₒ=nᵢ (FIG. 3a), but the maximum power when nₑ≠nᵢ (FIG. 3b). The power of the lens is variable between maximum and minimum in an analogue fashion, with the applied voltage. The example of the lens shown in FIG. 3 is created by depositing a transparent electrode on a substrate, the substrate having a curved surface, and then depositing a liquid crystal material on top of the substrate. A further substrate is then fashioned over the top of the structure with another electrode on it.

It should be noted that this is not the same implementation as is used in standard LCD displays. In the standard LCD displays the polarisation of the incoming light is usually changed, whereas in the present solution, the refractive index of the material can be changed leading to a different lens power. This means that the light lost is very close to zero, since no polarising filter is needed. The material being used may be e.g. a standard Twisted Nematic (TN) liquid crystal material. Instead of liquid crystal material, also other materials may be used, which are optically transparent and which change optical index over a suitable range with an applied voltage.

In the present solution a voltage switchable lens for CMOS pixel is presented. According to the present solution, in order to control the lens power of an individual pixel in a CMOS sensor, a vertically aligned electric field in a liquid crystal fluid is created above the already existing micro lens for that pixel. This can be achieved with a single electrode for the whole array on the bottom of the existing IR cut filter, and a separate electrical connection to the top of the pixel of the micro lens on a per pixel basis.

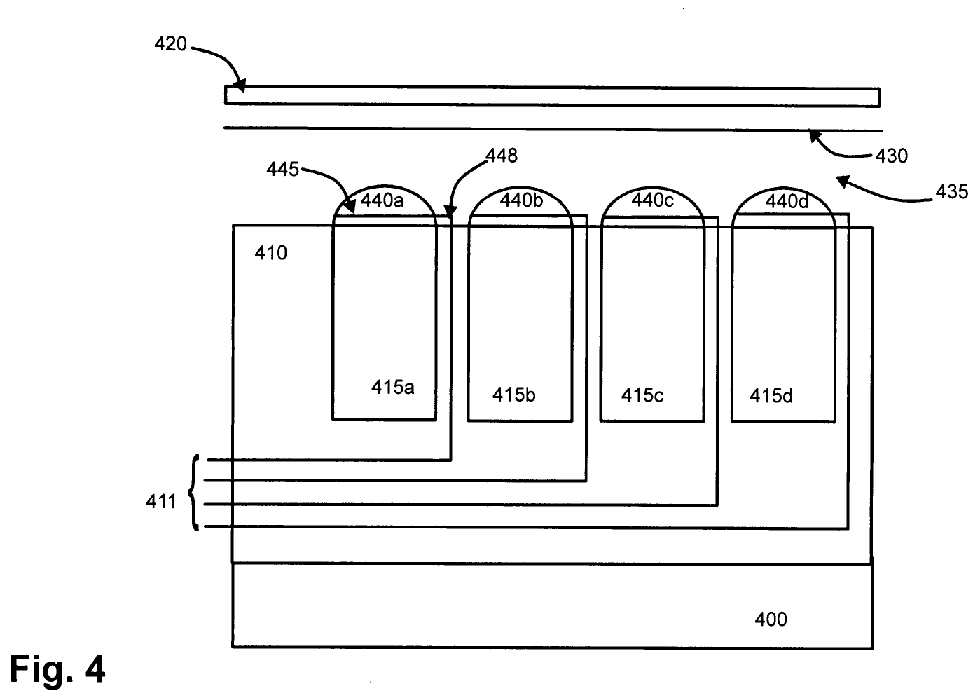

The wiring of individual pixels, or groups of pixels, can be part of the normal control and logic circuitry used for the control and readout of information. A connection from the bottom of the pixel to the top need only be high impedance (since no current flows) so metallic connection is not needed. For this reason the implementation of this is not critical. FIG. 4 illustrates a diagrammatic representation of the per-pixel optics with electrical connectivity according to the present solution.

In the example of FIG. 4, the optics comprises bulk silicon 400 that is doped with silicon 410 comprising active pixel 415a-415d and logic circuitry. Each individual pixel 415a-415d can be coated with a transparent electrode (see an electrode coating 445 for pixel 415a. The same is applied for the rest of the pixels 415b-415d). It is also possible that a transparent electrode covers more than one pixel. The transparent electrode may be located on top of a microlens 440a-440d, or under the microlens 440a-440d, i.e. directly on top of the pixel 415b-415d. The silicon 410 may also comprise the logic circuitry formed of individual connections 411 to the pixels 415a-415d in the normal circuitry layers. The connection 448 to electrode coating 445 on top of the pixel 415a well is used as an example. The same configuration is also applied to other pixels 415b-415d. On top of the pixel 415a-415d there is the microlens 440a-440d. The present optics structure also comprises a conventional glass sheet 420 and a transparent electrode coating 430 all over the glass's bottom surface. The gap 435 is for liquid crystal. It is appreciated that no separation between the pixels is required.

The per-pixel optics structure can be fabricated with standard IC development tools, which means that it will be as accurately aligned as the pixel itself, and that it might not be prohibitively expensive. The glass sheet 420 is normally present in a camera module, but according to the present solution a single transparent electrode 430 is sputtered over the surface of the glass sheet 420 by using common techniques used e.g. for display devices. The electrode coating 430 then needs to be connected to the printed wiring board substrate (400, 410) carrying the sensor, and a voltage needs to be developed between this electrode 430 and the individual connections 411 to the pixels 415a-415d. It should be noted that no current needs to flow and therefore it is not necessary to take a metallic connection to the top of the pixel. A high impedance connection to the sputtered electrode 445 on top of or underneath the microlens 440a-440d is sufficient.

It is also possible to take advantage of the electrical isolation of the pixel 415a-415d and raise or lower the whole pixel structure in voltage terms relative to the electrode 430 on the glass sheet 420, which would make the electrode 445 unnecessary. However this would mean that the field is generated over a larger distance, hence requiring more voltage to generate the same effect, and in addition the control and read out of the pixel would be problematic.

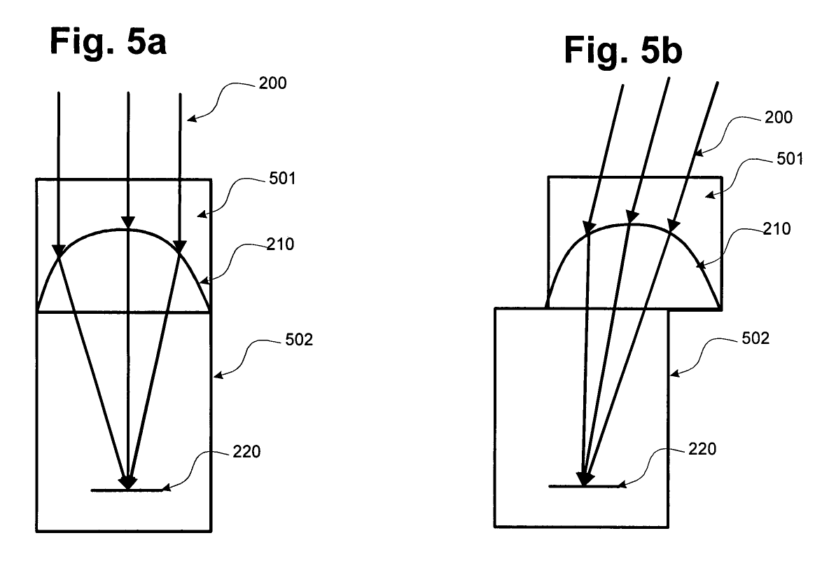

FIGS. 5a, 5b illustrate a micro lens/pixel structure with an optical element 501 created on top. In these figures, the optical element is a LCD cell 501 that covers one pixel. The LCD cell has substantially the same refractive index as air. Because of this, no effect is seen, and the light 200 is concentrated on the active area 220 of the pixel 502. Both figures illustrate a microlens 210 and the pixel 502 with LCD cell 501 as an optical element. It should be noted that the optical element may also cover more than one pixels. FIG. 5a represents the centre of the sensor, whereas FIG. 5b represents the edge of the sensor.

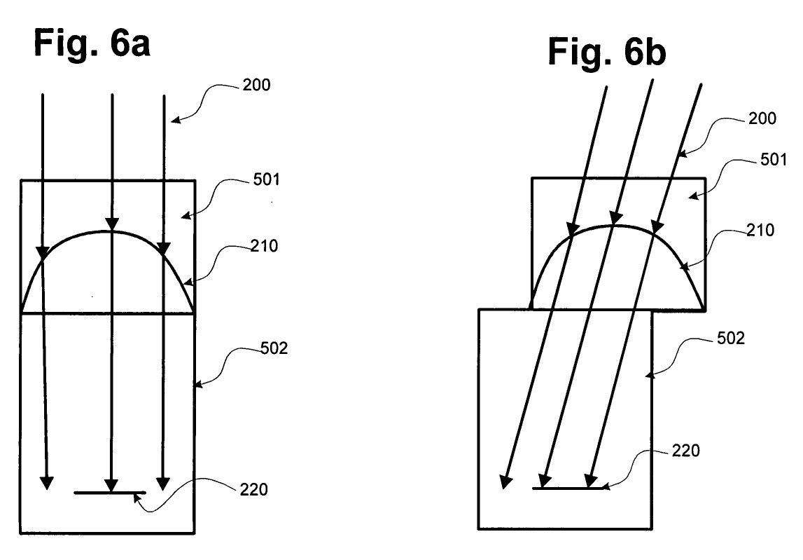

In FIGS. 6a and 6b, however, the refractive index of the LCD cell 501 is adjusted to be substantially the same as the material making the micro lens 210. No lensing action happens, i.e. the lens is disabled, and the light is no longer concentrated on the active area 220 of the pixel 502. Disabled lens has the effect of reducing the amount of light collected and turned into a signal. As in FIGS. 5a and 5b, also FIG. 6a represents centre of the sensor, whereas FIG. 6b represents edge of the sensor. It is appreciated that the refractive index can be varied in an analogue fashion, and all possibilities between these two extremes (between refractive indexes of FIGS. 5a, 5b and 6a, 6b) can be produced.

It is clear that for a particular pixel the lens power can be used to reduce the intensity of light detected; it can function as a neutral density filter if the whole array is adjusted by the same amount. This has the effect of emulating a function of a large expensive mechanical component (used in related art), with an IC scale component, which reduces size and increases the reliability and at the same time reducing cost.

However, the effect can be varied also from pixel to pixel, which makes even more applications possible. The lens power can be varied in an analogue manner across the cell to allow re-balancing of luminance and colour levels.

As an example, not all the pixels on the array gives the same colour information. A regular colour filter is placed over the pixels, so that they respond maximally to red, green or blue light. This is then recombined via an interpolation algorithm to give information to make an image. However the filters do not all have the same transparency to their respective wavelengths, and the pixel itself has a different response to a specific luminance level at a specific frequency.

This can be balanced up by a matrix included in the interpolation algorithm in the digital or software processing of the recovered data. The microlenses try to focus this light, but the different frequencies of light being filtered out will focus at slightly different points due to dispersion effects. Also across the sensor, the amount of this dispersion will vary. However, this can be adjusted on a per-pixel basis so that no colour matrix is needed and all lenses are optimum for their position and colour range of operation. This may lead to a higher (i.e. better) signal-to-noise ratio, since all the pixels collect all available light.

Similarly, the light level incident on the sensor tends to drop near the edge of the lens, resulting in a brighter image at the centre of the scene than at the edge. This can also be adjusted to be uniform by using the new microlens response.

In the above the liquid crystal was switched by modulating the refractive index. However, there are also other methods for switching the liquid crystal, such as for example by amplitude, as in an LCD display, which requires polarisers, or by diffraction effects for example

All of the previously described features correct defects or imperfection of the imaging module, which may not depend on the scene being imaged. Thus no feedback loop is needed.

In one example, the content of the scene being imaged can be analysed in a real time feedback loop to determine the areas of high and low illumination. The exposure illuminance levels of the pixels can then be adjusted to keep the amount of light reaching the pixels within the linear part of the pixels' response. This would enable a much higher dynamic range to be achieved, so that a scene with very bright and very dark portions could still be imaged, without either saturation of the bright parts or loss of detail in the dark parts. Therefore, for example, an image of a Christmas tree in a dark room with lots of fairy lights can be imaged accurately by giving enough processing power,

Another way of implementing high dynamic range is to attenuate light input to groups of pixel, which form sub-images. In post-processing, these sub-images can then be combined to form a high dynamic range image.

Edge or fringing effects in the image, when e.g. a bright point source of light or the sun is in the image, may be processed by setting the pixel lens to minimum transmission at the centre of the brightest part, and by setting the pixel lens to maximum away from the center. When the implementation is done as described then possible image artefacts are at the pixel spatial frequency, and can be filtered out in the de-interpolation algorithm as normal. If the pixels are grouped into arrays, as could be done to reduce computational complexity for example, then a more aggressive low pass filter in post processing would still be needed to remove the artefacts.

Yet another possible application is to form a mask on top of the sensor to perform pattern recognition or other transform image applications.

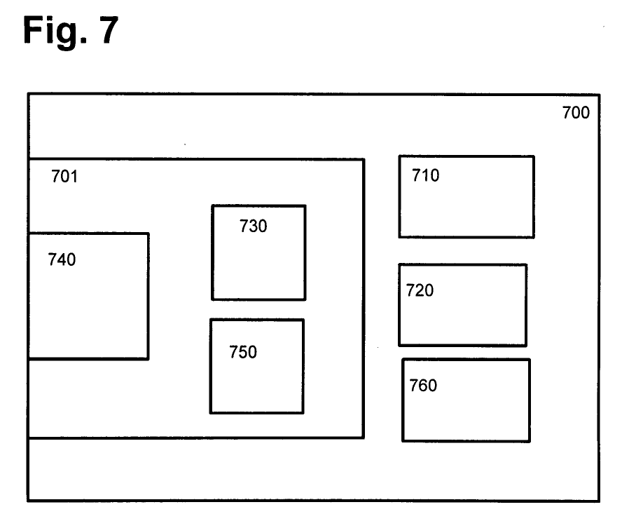

In the above, the present solution has been disclosed with an examples. It is appreciated that these examples are provided for understanding purposes. The present solution can be incorporated in digital cameras, mobile phones having a digital camera functionality or other imaging devices, being configured to capture still or video images according to specified method. A simplified example of such a device is illustrated in FIG. 7. The electronic device 700 comprises a camera module 701 for photographing. The camera module 701 further comprises lens 740 and image sensor 730, such as a CMOS sensor or a CCD sensor, and e.g. a autofocus unit 750. Further the electronic device 700 may comprise a processing circuit 720 and a memory 760. Yet further, the electronic device may comprise other electronic elements 710, such as a display, a user input means and telecommunication means. The present solution is applied to the image sensor 730.

It is appreciated that the electronic device may also comprise other elements that enhance the functionality of the device or the image sensor.

What is claimed is:

1. A device comprising
an image sensor having a group of pixels, wherein each pixel of said group of pixels comprises a microlens located on top of the pixel, said microlens being configured to transmit light to the pixel, and
at least one optical element, wherein each pixel of said group of pixels is covered with an optical element,
said optical element comprising two transparent electrode layers aligned with the covered pixels, and a material between said two transparent electrode layers, said material being configured to change its refractive index when a voltage is applied over it,
wherein the device is configured to control the transmission of the light to the covered pixels by varying the voltage of the electrode layer being aligned with the covered pixels.

2. The device according to claim 1, wherein one optical element is configured to cover one pixel.

3. The device according to claim 1, wherein one optical element is configured to cover more than one pixel.

4. The device according to claim 1, wherein the optical element is a liquid crystal element comprising liquid crystal material between the electrode layers.

5. The device according to claim 4, being configured to determine an optical index for the liquid crystal material to control the transmission of the light to the pixel.

6. The device according to claim 4, wherein one liquid crystal element is configured to cover one pixel.

7. The device according to claim 4, wherein one the liquid crystal element is configured to cover more than one pixels.

8. The device according to claim 1, comprising a glass sheet above the optical element.

9. The device according to claim 1, wherein one of the transparent electrode layers is located on top of the microlens.

10. The device according to claim 1, wherein one of the transparent electrode layers is located under the microlens.

11. The device according to claim 8, wherein the other of the transparent electrode layers is configured to cover one of the surfaces of the glass sheet.

12. A method
controlling the transmission of the light to covered pixels of an imaging device comprising at least an image sensor comprising a group of pixels and at least one optical element, wherein each pixel of said group of pixels comprises a microlens located on top of the pixel, said microlens being configured to transmit light to the pixel, and where each pixel of said group of pixels forming said covered pixels is covered with an optical element, said optical element comprising two transparent electrode layers and a material, the refractive index of which is changed when a voltage is applied over it, between said two transparent electrode layers, and wherein one of the transparent electrode layers is aligned with the covered pixels, said controlling by varying the voltage of the electrode layer being aligned with the covered pixels.

13. The method according to claim 12, wherein the optical element is a liquid crystal element comprising liquid crystal material between the electrode layers.

14. The method according to claim 13, comprising determining an optical index for the liquid crystal material to control the transmission of the light to the pixel.

15. A method for manufacturing an image sensor comprising:
covering each pixel of a group of pixels with an optical element, wherein each pixel of said group of pixels comprises a microlens located on top of the pixel, said microlens being configured to transmit light to the pixel, said optical element comprising two transparent electrode layers and a material, the refractive index of which is changed when a voltage is applied over it, between said two transparent electrode layers,
aligning one of the transparent electrode layers with the covered pixel,
the image sensor being configured to control the transmission of the light to the covered pixels by varying the voltage of the electrode layer being aligned with the covered pixels.

16. The method according to claim 15, comprising covering one pixel with one optical element.

17. The method according to claim 15, comprising covering more than one pixel with one optical element.

18. The method according to claim 15, wherein the optical element is a liquid crystal element comprising liquid crystal material between the electrode layers.

19. The method according to claim 18, comprising covering one pixel with one liquid crystal element.

20. The method according to claim 15, comprising placing a glass sheet above the optical element.

21. The method according to claim 15, comprising placing one of the transparent electrode layers on top of the microlens.

22. The method according to claim 15, comprising placing one of the transparent electrode layers under the microlens.

23. The method according to claim 20, comprising covering one of the surfaces of the glass sheet by the other of the transparent electrode layers.
